(19) United States
(12) Patent Application Publication
(10) Pub. No.: US 2023/0353589 A1
(43) Pub. Date: Nov. 2, 2023

(54) INTRUSION DETECTION DEVICE, INTRUSION DETECTION METHOD, AND NON-TRANSITORY COMPUTER READABLE MEDIUM

(71) Applicant: Mitsubishi Electric Corporation, Tokyo (JP)

(72) Inventors: Teruyoshi YAMAGUCHI, Tokyo (JP); Daisuke SUZUKI, Tokyo (JP)

(73) Assignee: Mitsubishi Electric Corporation, Tokyo (JP)

(21) Appl. No.: 18/213,492

(22) Filed: Jun. 23, 2023

Related U.S. Application Data
(63) Continuation of application No. PCT/JP2021/005894, filed on Feb. 17, 2021.

(51) Int. Cl. H04L 9/40

(52) U.S. Cl. CPC H04L 63/1425

(57) ABSTRACT

An intrusion detection device (101) includes a fragment calculation unit (103) and a determination unit (105). The fragment calculation unit (103) receives a fragmented packet that conforms to the Internet protocol suite as a received packet. The determination unit (105) determines whether each of entries included in a whitelist is a partial match entry that is decided depending on the received packet. A transmission source IP address and a target partial payload that are indicated in the partial match entry respectively match a transmission source IP address and a payload that are indicated in the received packet. The target partial payload is data located in an area that is in a payload of the partial match entry and starts at a location corresponding to a fragment offset indicated in the received packet.

### CROSS REFERENCE TO RELATED APPLICATIONS

This application is a Continuation of PCT International Application No. PCT/JP2021/005894 filed on Feb. 17, 2021, which is hereby expressly incorporated by reference into the present application.

### TECHNICAL FIELD

The present disclosure relates to an intrusion detection device, an intrusion detection method, and an intrusion detection program.

### BACKGROUND ART

There is a technology to detect whether a fragmented packet is a packet containing data that is not normal.

Patent Literature 1 discloses a technology that uses an automaton to detect whether a fragmented packet is a packet containing data that is not normal without reassembling the fragmented packet.

### CITATION LIST

### Patent Literature

Patent Literature 1: JP 2006-236080 A

### SUMMARY OF INVENTION

### Technical Problem

A case will be considered where a whitelist is used to detect whether a fragmented packet is a packet containing data that is not normal without reassembling the fragmented packet. In this case, since the technology disclosed in Patent Literature 1 uses an automaton, a problem is that data included in the whitelist is limited to data that conforms to a predetermined pattern. In this case, another problem is that a complex automaton needs to be prepared in advance.

An object of the present disclosure is to detect whether a fragmented packet that conforms to the Internet protocol suite is a packet containing data that is not normal without reassembling the packet by a relatively simple method using a whitelist that does not necessarily include only data that conforms to a predetermined pattern.

### Solution to Problem

An intrusion detection device according to the present disclosure refers to a database storing a whitelist for a packet that conforms to an Internet protocol suite,
the whitelist including entries called normal entries, each of which includes information indicating a transmission source IP address and information indicating a payload, and
the intrusion detection device includes
a fragment calculation unit to receive a fragmented packet that conforms to the Internet protocol suite as a received packet; and
a determination unit to perform determination processing, using the received packet, to determine whether each of the normal entries is a partial match entry that is decided depending on the received packet,
wherein a transmission source IP address and a target partial payload that are indicated in the partial match entry respectively match a transmission source IP address and a payload that are indicated in the received packet,
wherein the target partial payload is data located in an area in a payload of the partial match entry, the area starting at a location corresponding to a fragment offset indicated in the received packet, and
wherein a data size of the target partial payload is same as a data size of the payload indicated in the received packet.

### Advantageous Effects of Invention

According to the present disclosure, a determination unit compares a fragmented packet that conforms to the Internet protocol suite with entries included in a whitelist without reassembling the packet. Therefore, according to the present disclosure, it is possible to detect whether a fragmented packet that conforms to the Internet protocol suite is a packet containing data that is not normal without reassembling the packet by a relatively simple method using a whitelist that does not necessarily include only data that conforms to a predetermined pattern.

### BRIEF DESCRIPTION OF DRAWINGS

FIG. 1 is a figure illustrating an example of a configuration of an intrusion detection device 101 according to Embodiment 1;

FIG. 2 is a figure illustrating a specific example of a whitelist according to Embodiment 1;

FIG. 3 is a figure illustrating an example of a hardware configuration of the intrusion detection device 101 according to Embodiment 1;

FIG. 4 is a flowchart illustrating operation of the intrusion detection device 101 according to Embodiment 1;

FIG. 5 is a flowchart illustrating the operation of the intrusion detection device 101 according to Embodiment 1;

FIG. 6 is a flowchart illustrating the operation of the intrusion detection device 101 according to Embodiment 1;

FIG. 7 is a figure describing the operation of the intrusion detection device 101 according to Embodiment 1;

FIG. 8 is a figure illustrating an example of a hardware configuration of the intrusion detection device 101 according to a variation of Embodiment 1;

FIG. 9 is a figure illustrating an example of a configuration of the intrusion detection device 101 according to Embodiment 2;

FIG. 10 is a flowchart illustrating operation of the intrusion detection device 101 according to Embodiment 2;

FIG. 11 is a figure describing the operation of the intrusion detection device 101 according to Embodiment 2; and

FIG. 12 is a flowchart illustrating operation of a fragment calculation unit 103 according to Embodiment 2.

### DESCRIPTION OF EMBODIMENTS

In the description and drawings of embodiments, the same elements and corresponding elements are denoted by the same reference sign. The description of elements denoted by the same reference sign will be suitably omitted or simplified. Arrows in figures mainly indicate flows of data or flows of processing. “Unit” may be suitably interpreted as “circuit”, “step”, “procedure”, “process”, or “circuitry”.

### Embodiment 1

This embodiment will be described in detail below with reference to the drawings.

***Description of Configuration***

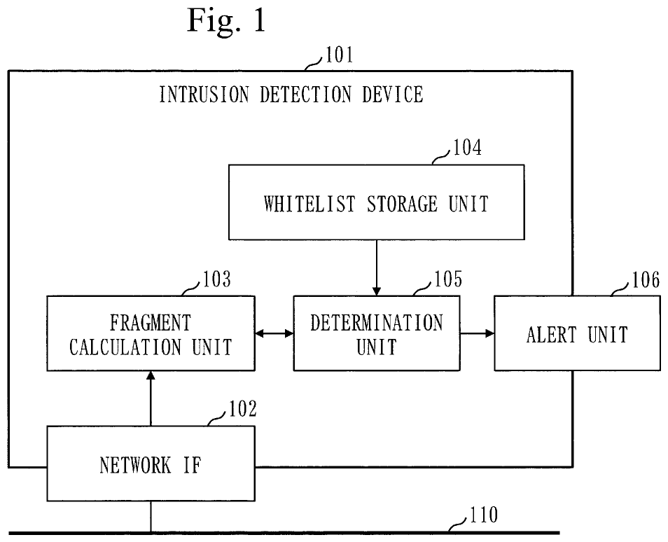

FIG. 1 illustrates an example of a configuration of an intrusion detection device 101 according to this embodiment. As illustrated in this figure, the intrusion detection device 101 includes a network interface (IF) 102, a fragment calculation unit 103, a whitelist storage unit 104, a determination unit 105, and an alert unit 106.

The intrusion detection device 101 may be installed at an intermediate place in a path through which a packet is transmitted from a transmission source of the packet to a transmission destination of the packet, or may be incorporated in a device or the like that is the transmission destination of the packet.

The network IF 102 is an interface between the intrusion detection device 101 and a bus 110, and receives a packet from the bus 110. Unless otherwise specified, a packet refers to a packet that conforms to the Internet protocol suite. The Internet protocol suite is also called the Transmission Control Protocol/Internet Protocol (TCP/IP). A packet received by the network IF 102 will be referred to as a received packet. The network IF 102 may receive a packet by wireless communication, and may be without connection to the bus 110. The network IF 102 is also a reception unit that receives a received packet.

The fragment calculation unit 103 receives a fragmented packet that conforms to the Internet protocol suite as a received packet, and performs processing using the received packet. The received packet may include information indicating a transmission source port number. The fragment calculation unit 103 manages, as management data, information that identifies an original packet and each piece of information indicating a normal entry identifier that identifies each partial match entry corresponding to at least one of fragmented packets of the original packet in association with each other. The original packet is a packet before IP fragmentation of an IP fragmented received packet. A transmission source IP address and a target partial payload that are indicated in a partial match entry respectively match a transmission source IP address and a payload that are indicated in the received packet. The target partial payload is data located in an area that is in the payload of the partial match entry and starts at a location corresponding to a fragment offset indicated in the received packet. The fragment offset is indicated in an IP header of the received packet. The data size of the target partial payload is the same as the data size of the payload indicated in the received packet. When the partial match entry includes information indicating a transmission source port number and the received packet includes information indicating a transmission source port number, the transmission source port number indicated in the partial match entry matches the transmission source port number indicated in the received packet.

The whitelist storage unit 104 stores a whitelist 31. The whitelist 31 is a set of detection rules for packets that conform to the Internet protocol suite. The whitelist 31 may include any number of detection rules. The whitelist storage unit 104 is also a database. The intrusion detection device 101 refers to the whitelist 31. Each of normal entries, which are entries included in the whitelist 31, includes information indicating a transmission source IP address and information indicating a payload. Each of the normal entries may include information indicating a transmission source port number. Data of each entry in the whitelist 31 may be data that does not conform to a predetermined pattern.

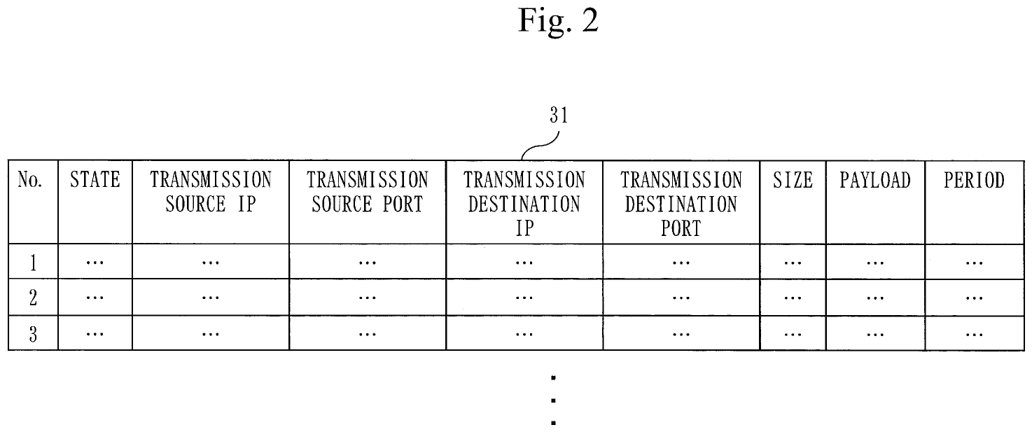

FIG. 2 illustrates a specific example of the whitelist 31 in a table format. One row in the table illustrated in this figure indicates one detection rule, and also indicates one entry in the whitelist 31. In this table, data in a “No.” column indicates an identifier of a detection rule, data in a “state” column indicates a condition regarding an operation state of a monitoring target system, data in a “transmission source IP” column indicates a transmission source IP address indicating a transmission source of a packet, data in a “transmission source port” column indicates a port number used when the packet is transmitted, data in a “transmission destination IP” column indicates a transmission destination IP address indicating a transmission destination of the packet, data in a “transmission destination port” column indicates a port number of the transmission destination of the packet, data in a “size” column indicates a data size of a payload of the packet, data in a “payload” column indicates data of the payload of the packet, and data in a “period” column indicates a period range according to which the transmission source should transmit packets. The data in the “No.” column is also data indicating a detection rule number. The monitoring target system is also a system which is the transmission destination of the packet and for which the intrusion detection device 101 is to detect intrusion. As a specific example, the value in the “state” column is one of “under control”, “starting up”, and “under maintenance”. As a specific example, when the value of the “state” column of a detection rule is “under control”, this detection rule is applied only when the state of the monitoring target system is “under control”. In a case where the original packet is IP fragmented, the data in each of the “size” column and the “payload” column is data regarding the original packet. IP fragmentation is also called fragmentation. The columns other than “No.” in the whitelist 31 indicate conditions. That is, as a specific example, the “size” column indicates a size condition, and the “payload” column indicates a payload condition.

The determination unit 105 refers to the whitelist storage unit 104, and determines whether the received packet contains attack data. Attack data is data that is not normal and may contain data intended for some kind of attack on the transmission destination of the packet. The determination unit 105 determines whether the received packet contains attack data by determining whether there is a correspondence between the received packet and at least one of the entries in the whitelist 31. The determination unit 105 determines whether attack data is trying to intrude into the transmission destination of the attack data. The determination unit 105 determines whether the received packet satisfies each condition indicated in the whitelist 31. The determination unit 105 determines whether the received packet contains attack data by performing determination processing that uses the received packet to determine whether each of the normal entries is a partial match entry that is decided depending on the received packet. The determination unit 105 performs the same processing as the determination processing on each different packet that is a fragmented packet of the original packet and is different from the received packet.

If the received packet is not IP fragmented and there is a correspondence between an entry in the whitelist 31 and the received packet, pieces of data indicated in the “transmission source IP” column, the “transmission source port” column, the “transmission destination IP” column, the “transmission destination port” column, the “size” column, and the “payload” column of this entry respectively match the transmission source IP address indicated in the received packet, the transmission source port indicated in the received packet, the transmission destination IP address indicated in the received packet, the transmission destination port indicated in the received packet, the data size of the payload indicated in the received packet, and the payload indicated in the received packet.

If the received packet is IP fragmented and there is a correspondence between an entry in the whitelist 31 and the received packet, there are differences regarding the “size” column and the “payload” column of this entry from the above case where the received packet is not IP fragmented and there is a correspondence between an entry in the whitelist 31 and the received packet. Specifically, data in the “size” column of this entry does not match the data size of the payload of the received packet, and a target partial payload that is part of data in the “payload” column of this entry matches the payload of the received packet.

If the received packet is IP fragmented, the determination unit 105 checks whether the data in the “size” column matches the data size of the payload of the original packet, and checks whether the data in the “period” column matches the period of receiving the received packet.

If the received packet does not include a TCP header, a correspondence between an entry in the whitelist 31 and the received packet is decided regardless of the data in the “transmission source port” column and the “transmission destination port” column.

A case will be considered where the data corresponding to the original packet is being managed through the management data and the determination unit 105 has not performed the determination processing on the received packet. In this case, in the determination processing on the received packet, the determination unit 105 uses, among the normal entries, only narrowed-down entries composed of normal entries respectively corresponding to normal entry identifiers corresponding to the original packet and indicated in the management data. After the determination unit 105 has performed the determination processing, the fragment calculation unit 103 deletes, from the management data, information indicating a normal entry identifier corresponding to the original packet and corresponding to a normal entry determined not to be a partial match entry for the received packet in the determination processing, among the normal entries included in the narrowed-down entries.

If the received packet contains attack data, that is, if it is determined by the determination unit 105 that no partial match entry is included in the whitelist 31, the alert unit 106 issues an alert. The alert is to notify that the received packet contains attack data. The alert unit 106 may issue the alert by displaying an alert message on a screen, or may issue the alert by outputting sound.

The bus 110 is, as a specific example, a local area network (LAN) cable.

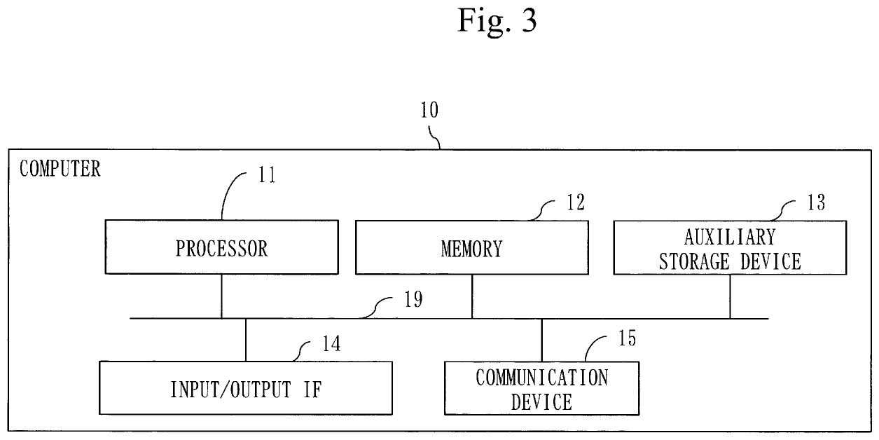

FIG. 3 illustrates an example of a hardware configuration of the intrusion detection device 101 according to this embodiment. The intrusion detection device 101 is composed of a computer 10. The intrusion detection device 101 may be composed of a plurality of computers 10.

As illustrated in this figure, the computer 10 is a computer that includes hardware such as a processor 11, a memory 12, an auxiliary storage device 13, an input/output IF 14, and a communication device 15. These hardware components are connected as appropriate though a signal line 19.

The processor 11 is an integrated circuit (IC) that performs operational processing, and controls the hardware included in the computer. The processor 11 is, as a specific example, a central processing unit (CPU), a digital signal processor (DSP), or a graphics processing unit (GPU).

The intrusion detection device 101 may include a plurality of processors as an alternative to the processor 11. The plurality of processors share the role of the processor 11.

The memory 12 is, typically, a volatile storage device. The memory 12 is also called a main storage device or a main memory. The memory 12 is, as a specific example, a random access memory (RAM). Data stored in the memory 12 is saved in the auxiliary storage device 13 as necessary.

The auxiliary storage device 13 is, typically, a non-volatile storage device. The auxiliary storage device 13 is, as a specific example, a read only memory (ROM), a hard disk drive (HDD), or a flash memory. Data stored in the auxiliary storage device 13 is loaded into the memory 12 as necessary.

The memory 12 and the auxiliary storage device 13 may be configured integrally.

The input/output IF 14 is a port to which an input device and an output device are connected. The input/output IF 14 is, as a specific example, a Universal Serial Bus (USB) terminal. The input device is, as a specific example, a keyboard and a mouse. The output device is, as a specific example, a display.

The communication device 15 is a receiver and a transmitter. The communication device 15 is, as a specific example, a communication chip or a network interface card (NIC). The network IF 102 is realized by the communication device 15.

Each unit of the intrusion detection device 101 may use the communication device 15 as appropriate when communicating with other devices or the like. Each unit of the intrusion detection device 101 may accept data via the input/output IF 14, or may accept data via the communication device 15.

The auxiliary storage device 13 stores an intrusion detection program. The intrusion detection program is a program that causes a computer to execute the functions of each unit included in the intrusion detection device 101. The intrusion detection program is loaded into the memory 12 and executed by the processor 11. The functions of each unit included in the intrusion detection device 101 are realized by software.

Data used when the intrusion detection program is executed, data obtained by executing the intrusion detection program, and so on are stored in a storage device as appropriate. Each unit of the intrusion detection device 101 uses the storage device as appropriate. As a specific example, the storage device is composed of at least one of the memory 12, the auxiliary storage device 13, a register in the processor 11, and a cache memory in the processor 11. Data and information may have substantially the same meaning. The storage device may be independent of the computer 10. The storage device stores the whitelist 31 and a database 32.

The functions of the memory 12 and the auxiliary storage device 13 may be realized by other storage devices.

The intrusion detection program may be recorded in a computer readable non-volatile recording medium. The non-volatile recording medium is, as a specific example, an optical disc or a flash memory. The intrusion detection program may be provided as a program product.

***Description of Operation***

A procedure for operation of the intrusion detection device 101 is equivalent to an intrusion detection method. A program that realizes the operation of the intrusion detection device 101 is equivalent to the intrusion detection program.

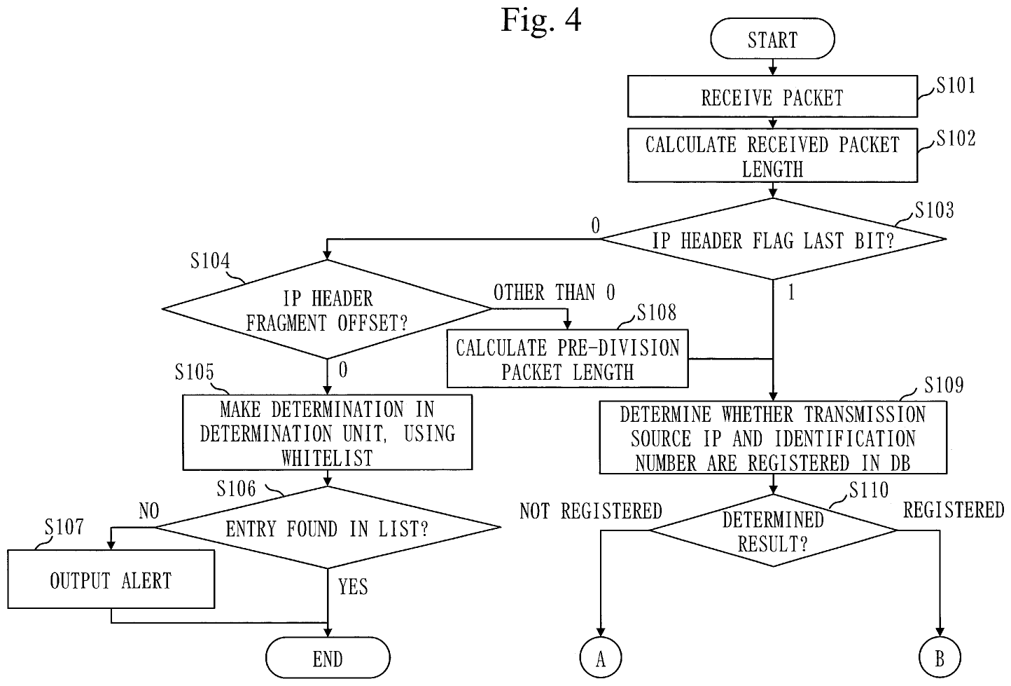

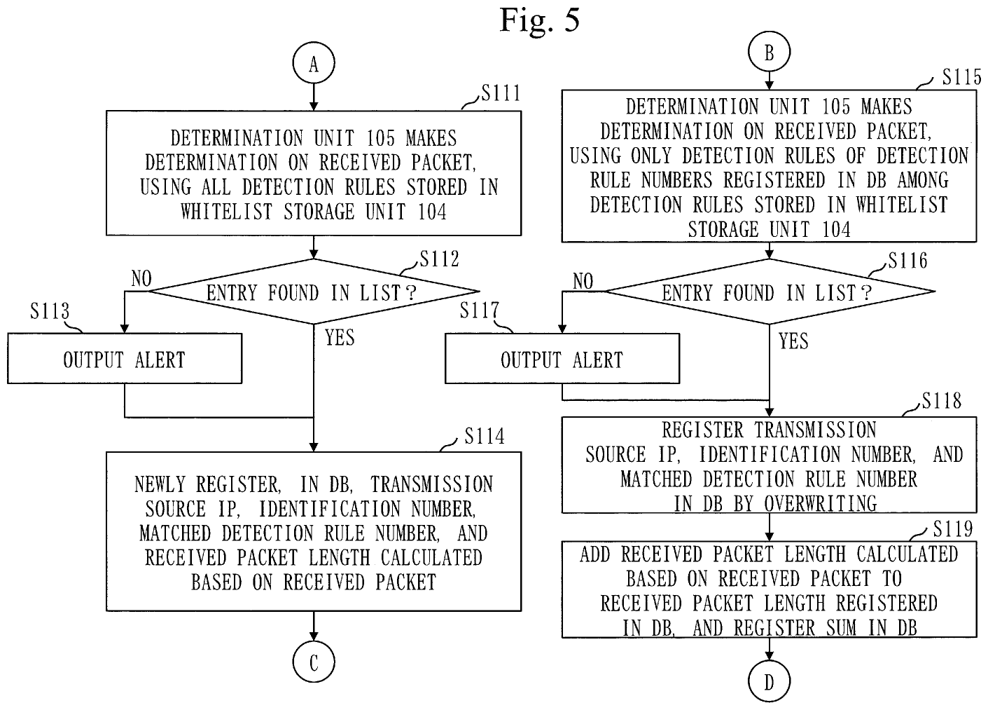

FIGS. 4 to 6 are a flowchart illustrating an example of the operation of the intrusion detection device 101. One flowchart is divided and illustrated in FIGS. 4 to 6. Referring to FIGS. 4 to 6, the operation of the intrusion detection device 101 will be described. In the following description, it is assumed that the intrusion detection device 101 uses a detection rule whose condition indicated in the “state” column is satisfied.

(Step S101)

The network IF 102 receives a packet from the bus 110, and transmits the received packet to the fragment calculation unit 103. In the following description of this flowchart, the received packet refers to the packet received by the network IF 102 in this step unless otherwise specified.

(Step S102)

The fragment calculation unit 103 refers to the IP header of the received packet to obtain a received packet length. In the following description of this flowchart, the received packet length is the data size of the payload of the received packet, and is a value obtained by [Formula 1]. The fragment calculation unit 103 uses data indicated in the IP header of the received packet as each of the total length and the header length in [Formula 1]. The unit of the value of the received packet length is byte. Note that a representation [character string] in [Formula 1] and the like denotes a numerical value corresponding to the character string.

[Received packet length]=[total length]−[header length]×4 [Formula 1]

(Step S103)

The fragment calculation unit 103 checks the last bit of flag indicated in the IP header of the received packet. If the value of the last bit is 0, the intrusion detection device 101 proceeds to step S104. In other cases, the intrusion detection device 101 proceeds to step S109.

If the received packet is an IP fragmented packet and the value of the last bit of flag is 0, the received packet is a last packet. The last packet is an IP fragmented packet of the original packet, and contains data of the end portion of the payload of the original packet.

(Step S104)

The fragment calculation unit 103 checks a fragment offset indicated in the IP header of the received packet. If the value of the fragment offset is 0, the intrusion detection device 101 proceeds to step S105. In other cases, the intrusion detection device 101 proceeds to step S108.

(Step S105)

The determination unit 105 refers to the whitelist storage unit 104, and determines whether there is a correspondence between one of the entries in the whitelist 31 and the received packet.

(Step S106)

If there is a correspondence between one of the entries in the whitelist 31 and the received packet, the intrusion detection device 101 terminates processing of this flowchart. In other cases, the intrusion detection device 101 proceeds to step S107.

(Step S107)

The alert unit 106 outputs an alert.

(Step S108)

The fragment calculation unit 103 obtains a pre-division packet length. The pre-division packet length is the data size of the payload of the original packet, and is obtained by [Formula 2]. The original packet is data before IP fragmentation of the received packet. The fragment calculation unit 103 uses the fragment offset indicated in the IP header of the received packet as the fragment offset in [Formula 2], and uses the received packet length obtained in step S102 as the received packet length in [Formula 2]. The unit of the value of the pre-division packet length is byte.

[Pre-division packet length]=[fragment offset]×8+[received packet length] [Formula 2]

(Step S109)

The fragment calculation unit 103 determines whether the transmission source IP address and identification number indicated in the IP header of the received packet are registered in the database 32. The database 32 records data corresponding to received packets that are IP fragmented and received by the intrusion detection device 101, and collectively manages the data according to the transmission source IP address and identification number indicated in the IP header of each received packet. That is, if the intrusion detection device 101 has received two received packets that differ in at least one of the transmission source IP address and identification number indicated in the IP header of each received packet, the database 32 separately manages data corresponding to each of the two received packets. “DB” is an abbreviation for database. In the following description of this flowchart, an entry that is in the database 32 and has a correspondence to both of the transmission source IP address and identification number indicated in the IP header of the received packet will be referred to as a recording-target entry.

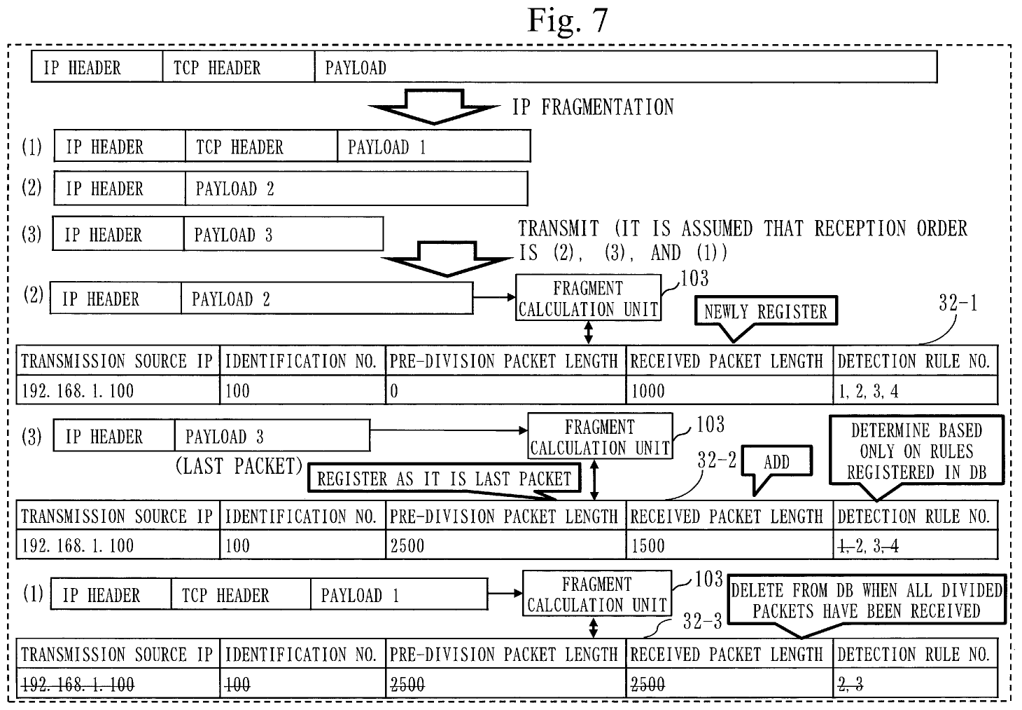

FIG. 7 is a figure describing the operation of the intrusion detection device 101. This figure describes the operation in which the original packet indicated at the top of this figure is divided into three packets by IP fragmentation, and the intrusion detection device 101 sequentially receives the three IP fragmented packets. It is assumed that the intrusion detection device 101 first receives the packet corresponding to (2), then receives the packet corresponding to (3), and then receives the packet corresponding to (1). The payload of the original packet is data that follows the TCP header of the original packet. The payload of a received packet is data that follows the TCP header of the received packet or data that follows the IP header of the received packet. This figure illustrates a specific example of the database 32 in a table format. In this figure, the database 32 is represented by a table that has a “transmission source IP” column, an “identification No.” column, a “pre-division packet length” column, a “received packet length” column, and a “detection rule No.” column. In the “transmission source IP” column, an IP address indicated in the IP header of the received packet is recorded. In the “identification No.” column, an identification number indicated in the IP header of the received packet is recorded. In the “pre-division packet length” column, a pre-division packet length as described above is recorded. In the “received packet length” column, a cumulative value of the data sizes of the payloads of IP fragmented packets of the original packet received by the intrusion detection device 101 is recorded. The database 32 illustrated in this figure collectively manages the packets that have been received by the intrusion detection device 101, and have “192.168.1.100” as the transmission source IP address indicated in the IP header and have 100 as the value of the identification number indicated in the IP header. One row in the database 32 of this figure corresponds to one original packet, corresponds to one combination of the transmission source IP address and identification number indicated in the IP header of the received packet, and constitutes one entry in the database 32. Note that the top row in the database 32 of this figure where the labels of the columns are indicated is not regarded as a row of the database 32. In a case where, with regard to a plurality of received packets received by the intrusion detection device 101, there are a plurality of types of combination of the transmission source IP address and identification number indicated in the IP header of each received packet, when the database 32 is represented in a table format as illustrated in FIG. 7, the number of rows of the database 32 is the number of types of combination of the transmission source IP address and identification number. Note that “−1” and the like in this figure are representations for distinguishing a plurality of databases 32 with mutually different contents. Each entry in the database 32 is also management data. Data in the “transmission source IP” column and the “identification No.” column is also information that identifies the original packet. Data in the “detection rule No.” column is also a normal entry identifier.

(Step S110)

If the transmission source IP address and identification number indicated in the IP header of the received packet respectively correspond to the data in the “transmission source IP” column and the data in the “identification No.” column of one entry in the database 32, the intrusion detection device 101 proceeds to step S115. In other cases, the intrusion detection device 101 proceeds to step S111.

(Step S111)

The determination unit 105 determines whether the received packet contains attack data, using all the detection rules included in the whitelist 31. At this time, the determination unit 105 determines whether each entry in the whitelist 31 is a partial match entry, and determines that the received packet contains attack data if there is no partial match entry in the whitelist 31. A partial match entry is an entry in the whitelist 31, and there may be a plurality of partial match entries. The data in the “transmission source port” column, the data in the “transmission destination port” column, and the target partial payload of the data in the “payload” column of the partial match entry respectively match the transmission source port number indicated in the TCP header of the received packet, the transmission destination port number indicated in the TCP header, and the payload of the received packet. The starting point of the target partial payload is the ([fragment offset]×8+1)-th byte of the data in the “payload” column. The end point of the target partial payload is the ([fragment offset]×8+[received packet length])-th byte of the data in the “payload” column. A port number is a general term for a transmission source port number and a transmission destination port number.

If the received packet includes no TCP header, the determination unit 105 makes no determination regarding the “transmission source port” column and the “transmission destination port” column. That is, in this case, the target partial payload of the data in the “payload” column of the partial match entry matches the payload of the received packet.

(Step S112)

If the whitelist 31 includes at least one partial match entry, the intrusion detection device 101 proceeds to step S114. In other cases, the intrusion detection device 101 proceeds to step S113.

(Step S113)

Processing in this step is substantially the same as processing in step S107.

(Step S114)

The fragment calculation unit 103 newly registers, in the database 32, the transmission source IP address and identification number indicated in the IP header of the received packet, the value of the received packet length obtained in step S102, and every detection rule number corresponding to every partial match entry determined in step S111. If the whitelist 31 includes no partial match entry, the fragment calculation unit 103 registers, in the database 32, data indicating that there is no partial match entry, instead of registering detection rule numbers in the database 32. In this case, the fragment calculation unit 103 may set 0 in a parameter indicating the number of detection rules.

As a specific example, the fragment calculation unit 103 newly registers data as indicated in a database 32-1.

(Step S115)

Processing in this step is substantially the same as processing in step S111. However, the determination unit 105 does not necessarily use all the detection rules included in the whitelist 31. Specifically, the determination unit 105 uses only the detection rules corresponding to the detection rule numbers recorded in the “detection rule No.” column of the database 32. Entries in the whitelist 31 corresponding to these detection rule numbers will be referred to as target entries.

As a specific example, if the database 32 at the time this step is performed is the database 32-1, the determination unit 105 determines whether each entry corresponding to a detection rule whose detection rule number is one of 1, 2, 3, and 4 is a partial match entry. In this example, the target entries are a set of entries each with a detection rule number corresponding to one of 1, 2, 3, and 4.

(Step S116)

If the target entries include at least one partial match entry, the intrusion detection device 101 proceeds to step S118. In other cases, the intrusion detection device 101 proceeds to step S117.

(Step S117)

Processing in this step is substantially the same as processing in step S107.

(Step S118)

The fragment calculation unit 103 narrows down the data recorded in the “detection rule No.” column of the recording-target entry to data corresponding to each detection rule number corresponding to each partial match entry determined in step S115. If the target entries include no partial match entry, the fragment calculation unit 103 deletes the data recorded in the “detection rule No.” column of the recording-target entry. In this case, the fragment calculation unit 103 may set 0 in the parameter indicating the number of detection rules.

In the specific example illustrated in FIG. 7, the fragment calculation unit 103 deletes data indicating 1 and 4 from the “detection rule No.” column in the database 32-1, as indicated in the “detection rule No.” column of a database 32-2. In this example, there is a correspondence between each entry corresponding to one of the detection rule numbers 2 and 3 and the received packet. In this example, normal entries corresponding to detection rules of detection rule numbers 1 and 4 are determined not to be partial match entries for the received packet (3).

(Step S119)

The fragment calculation unit 103 updates the value indicated in the “received packet length” column of the recording-target entry to a value obtained by adding, to this value, the value of the received packet length obtained in step S102.

As a specific example, the fragment calculation unit 103 updates the value indicated in the “received packet length” column by adding the value of the received packet length obtained in step S102 to the value indicated in the “received packet length” column, as indicated in the database 32-2 of FIG. 7. In this example, the data size of a payload 3 is 500 bytes.

(Step S120)

If the pre-division packet length has been obtained in step S108, the fragment calculation unit 103 registers the value of the pre-division packet length in the “pre-division packet length” column of the recording-target entry.

As a specific example, the fragment calculation unit 103 registers the data size of the payload of the original packet in the “pre-division packet length” column of the database 32-1, as indicated in the database 32-2 of FIG. 7. In this example, the data size of the payload of the original packet is 2500 bytes.

(Step S121)

The determination unit 105 determines whether a value is registered in the “pre-division packet length” column of the recording-target entry.

If a value is registered in the “pre-division packet length” column of the recording-target entry, the intrusion detection device 101 proceeds to step S122. In other cases, the intrusion detection device 101 terminates processing of this flowchart.

(Step S122) The determination unit 105 determines whether the value in the “pre-division packet length” column of the recording-target entry matches the value in the “received packet length” column of the recording-target entry.

If the value in the “pre-division packet length” column of the recording-target entry matches the value in the “received packet length” column of the recording-target entry, the intrusion detection device 101 proceeds to step S123. In other cases, the intrusion detection device 101 terminates processing of this flowchart.

(Step S123)

With regard to the data size of the payload of the original packet and the period of the original packet, the determination unit 105 determines whether there is a correspondence between an entry corresponding to each value indicated in the “detection rule No.” column of the recording-target entry and the original packet. The determination unit 105 determines the presence of the correspondence if the data size of the payload of the original packet matches the data size indicated in the “size” column of an entry corresponding to a value indicated in the “detection rule No.” column, and the reception period for the original packet is within the period range indicated in the “period” column of this entry. Specifically, the determination unit 105 decides the reception time of the original packet at the time point when all the fragmented packets of the original packet have been received, and calculates a period based on a gap between the reception time of the original packet and the time of preceding reception of a packet with the same conditions as the original packet, and determines whether the calculated period is within the period range indicated in the “period” column.

If a packet with the same conditions as those of the original packet has not been received, the determination unit 105 may omit making a determination regarding the period.

(Step S124)

If the correspondence in step S123 is found between an entry corresponding to any value indicated in the “detection rule No.” column of the recording-target entry and the original packet, the intrusion detection device 101 proceeds to step S126. In other cases, the intrusion detection device 101 proceeds to step S125.

(Step S125)

Processing in this step is substantially the same as processing in step S107.

(Step S126) The fragment calculation unit 103 deletes the recording-target entry from the database 32.

As a specific example, the fragment calculation unit 103 deletes the recording-target entry in the database 32-2, as indicated in a database 32-3 of FIG. 7.

After completion of processing of this step, the intrusion detection device 101 terminates processing of this flowchart.

Before terminating processing of this flowchart, the fragment calculation unit 103 deletes the received packet as appropriate.

***Description of Effects of Embodiment 1***

As described above, according to this embodiment, attack data can be detected without reassembling IP fragmented packets into the original packet. Therefore, according to this embodiment, the amount of memory used for detecting attack data can be reduced. In addition, according to this embodiment, attack data can be detected relatively simply by using the database 32. Furthermore, according to this embodiment, attack data can be detected relatively quickly by gradually narrowing down the detection rules, using the “detection rule No.” column of the database 32.

***Other Configurations***<

### <Variation 1>

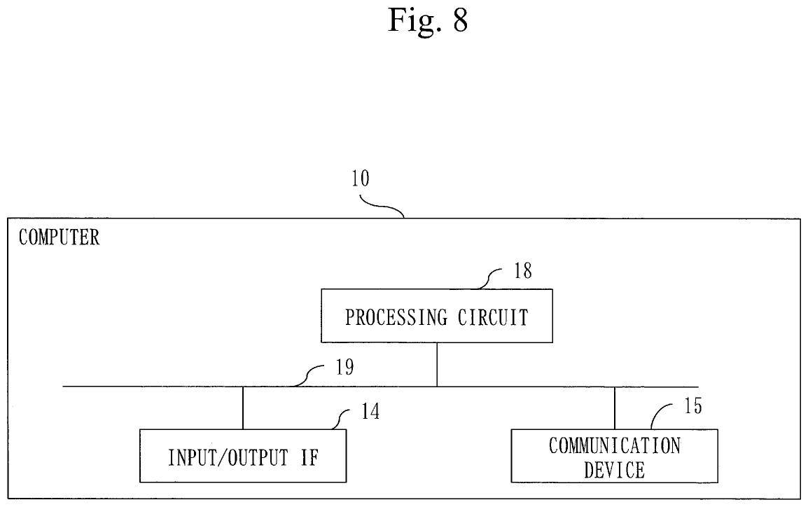

FIG. 8 illustrates an example of a hardware configuration of the intrusion detection device 101 according to this variation.

As illustrated in this figure, the intrusion detection device 101 includes a processing circuit 18 in place of at least one of the processor 11, the memory 12, and the auxiliary storage device 13.

The processing circuit 18 is hardware that realizes at least part of the units included in the intrusion detection device 101.

The processing circuit 18 may be dedicated hardware, or may be a processor that executes programs stored in the memory 12.

When the processing circuit 18 is dedicated hardware, the processing circuit 18 is, as a specific example, a single circuit, a composite circuit, a programmed processor, a parallel-programmed processor, an application specific integrated circuit (ASIC), a field programmable gate array (FPGA), or a combination of these.

The intrusion detection device 101 may include a plurality of processing circuits as an alternative to the processing circuit 18. The plurality of processing circuits share the role of the processing circuit 18.

In the intrusion detection device 101, some functions may be realized by dedicated hardware, and the remaining functions may be realized by software or firmware.

As a specific example, the processing circuit 18 is realized by hardware, software, firmware, or a combination of these.

The processor 11, the memory 12, the auxiliary storage device 13, and the processing circuit 18 are collectively called “processing circuitry”. That is, the functions of the functional components of the intrusion detection device 101 are realized by the processing circuitry.

The intrusion detection device 101 according to other embodiments may be configured similarly to this variation.

Embodiment 2.

Differences from the above embodiment will be described with reference to the drawings.

***Description of Configuration***

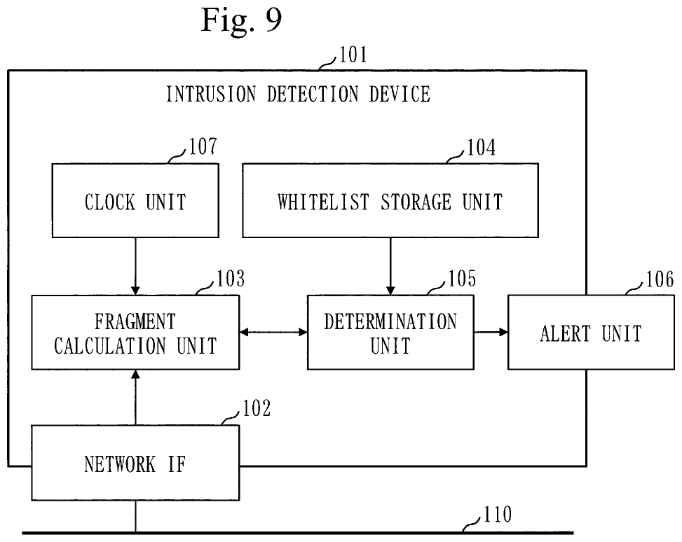

FIG. 9 illustrates the intrusion detection device 101 according to this embodiment. As illustrated in this figure, the intrusion detection device 101 includes a clock unit 107 in addition to the constituent elements included in the intrusion detection device 101 according to Embodiment 1.

The clock unit 107 includes a clock, and informs the fragment calculation unit 103 of the time indicated by the clock.

The fragment calculation unit 103 according to this embodiment deletes old entries in the database 32. The fragment calculation unit 103 records, as a reception time, a time corresponding to the time of reception of the received packet by the intrusion detection device 101. If a deletion time period has elapsed from the reception time and the fragment calculation unit 103 is managing data corresponding to the received packet through management data, the fragment calculation unit 103 deletes the data corresponding to the received packet in the management data.

***Description of Operation***

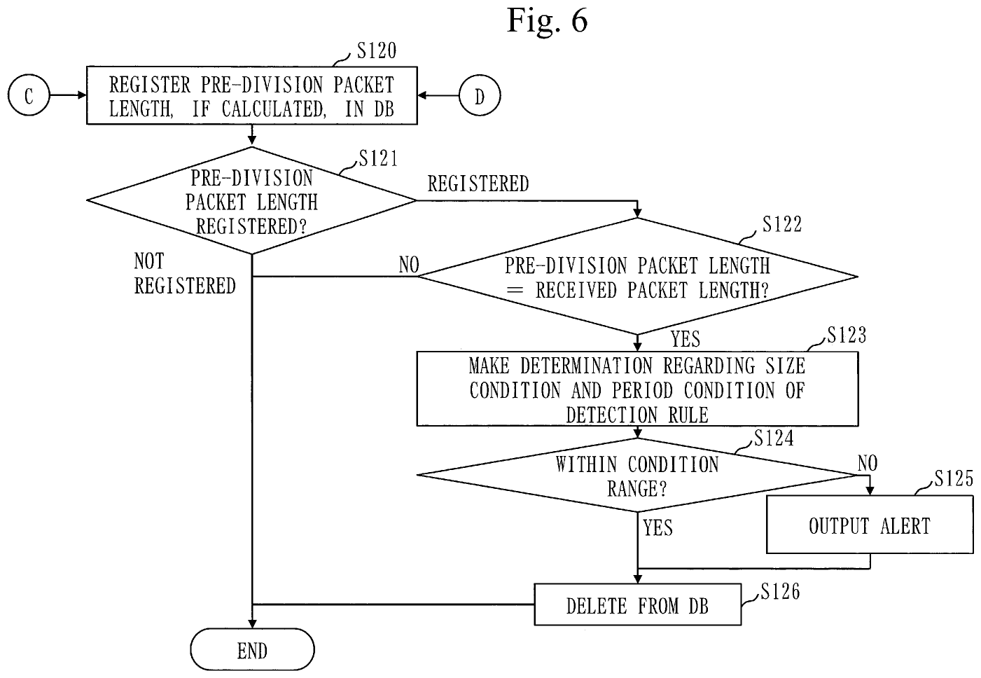

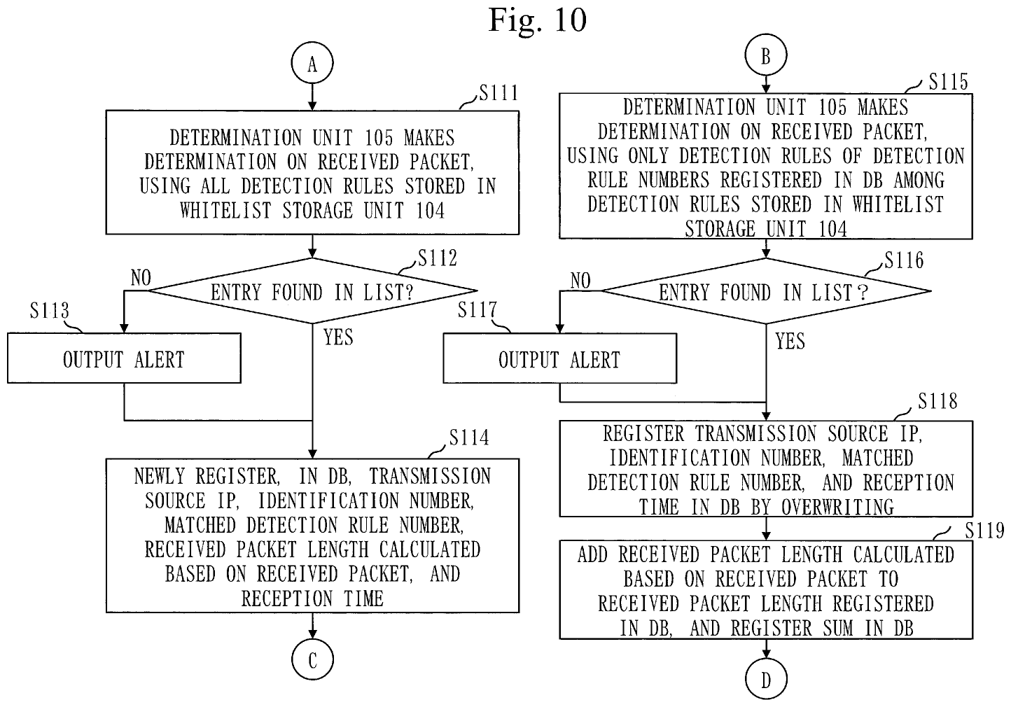

FIG. 10 illustrates part of a flowchart illustrating an example of the operation of the intrusion detection device 101. Referring to this figure, differences between the intrusion detection device 101 according to Embodiment 1 and the intrusion detection device 101 according to this embodiment will be mainly described. The intrusion detection device 101 according to this embodiment also performs processing illustrated in FIGS. 4 and 6.

(Step S114)

Processing in this step is substantially the same as processing in step S114 according to Embodiment 1. However, the fragment calculation unit 103 refers to the clock unit 107, and records the time of reception of the received packet by the intrusion detection device 101 in a “reception time” column of the recording-target entry.

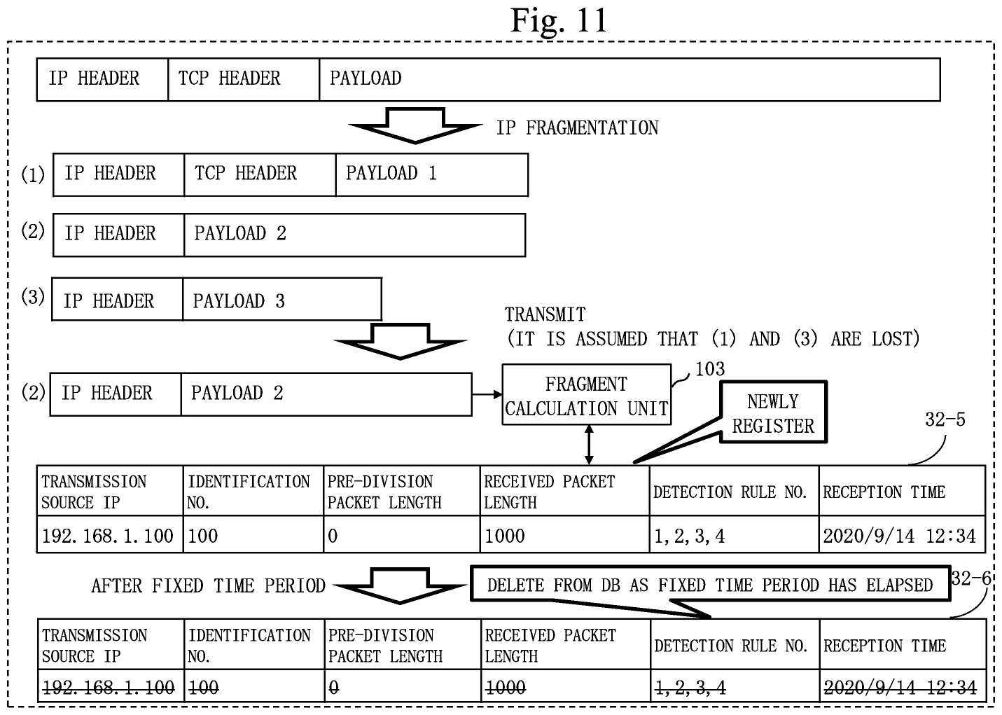

FIG. 11 is a figure describing the operation of the intrusion detection device 101. This figure is similar to FIG. 7. However, the database 32 according to this embodiment has the “reception time” column. In the “reception time” column, the time of reception of the received packet is recorded.

As a specific example, in this step, the fragment calculation unit 103 registers the time of reception of the received packet corresponding to (2) of FIG. 11 by the intrusion detection device 101 in the “reception time” column of the recording-target entry, as indicated in a database 32-5 of FIG. 11. This time may be a time that does not exactly match the time of reception of the received packet by the intrusion detection device 101.

(Step S118)

Processing in this step is substantially the same as processing in step S118 according to Embodiment 1. However, the fragment calculation unit 103 refers to the clock unit 107, and registers the time of reception of the received packet by the intrusion detection device 101 in the “reception time” column of the recording-target entry. Typically, the fragment calculation unit 103 updates the time registered in the “reception time” column to the time of reception of the received packet.

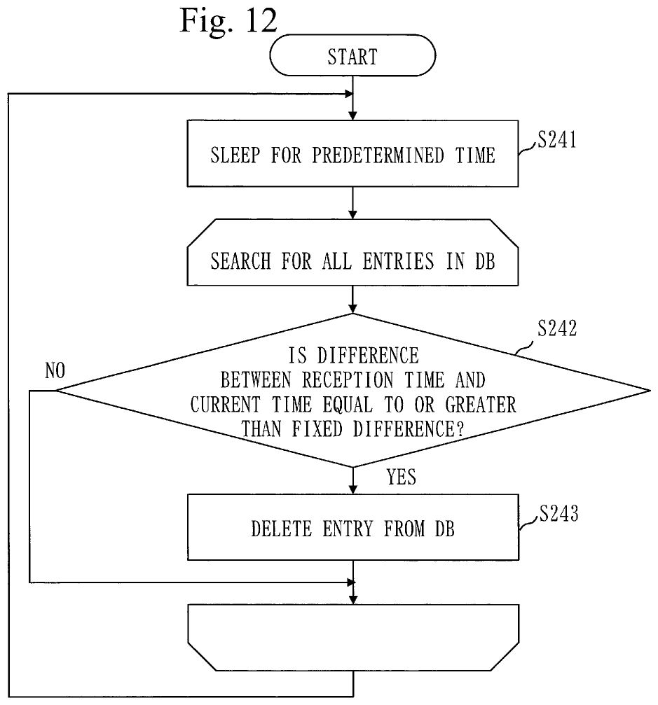

FIG. 12 is a flowchart illustrating an example of the operation of the fragment calculation unit 103. Processing indicated in this flowchart is typically performed in parallel with processing in the flowchart described above. Referring to this figure, the operation of the fragment calculation unit 103 will be described.

(Step S241)

The fragment calculation unit 103 goes into a sleep state for a predetermined time. The predetermined time may be a fixed value or may be changed as appropriate during operation of the intrusion detection device 101.

After the fragment calculation unit 103 has been in the sleep state for the predetermined time, the fragment calculation unit 103 performs iterative processing composed of step S242 and step S243. In the iterative processing, the fragment calculation unit 103 performs searches on all entries in the database 32.

(Step S242)

The fragment calculation unit 103 selects, as a selected entry, one entry in the database 32 that has not been selected in this iterative processing, and checks the “reception time” column of the selected entry. The fragment calculation unit 103 also refers to the clock unit 107 to check the current time. If a difference between the time indicated in the “reception time” column of the selected entry and the current time is equal to or greater than a fixed difference, the fragment calculation unit 103 determines that a loss of a packet has occurred, and proceeds to step S243. Note that if the difference is equal to or greater than the fixed difference, the deletion time period has elapsed from the time indicated in the “reception time” column. In other cases, the fragment calculation unit 103 skips step S243.

(Step S243)

The fragment calculation unit 103 deletes the selected entry from the database 32.

As a specific example, as indicated in FIG. 11, if the intrusion detection device 101 cannot receive any of packets corresponding to (1) and (3) even after a fixed time period has elapsed since the intrusion detection device 101 had received the packet corresponding to (2), the fragment calculation unit 103 deletes the entry corresponding to (2) in the database 32-5 so as to update the database 32-5 to a database 32-6. In this case, the fragment calculation unit 103 judges that the packets corresponding to (1) and (3) have been lost.

***Description of Effects of Embodiment 2***

As described above, according to this embodiment, an entry corresponding to a packet concerning which a loss is considered to have occurred is deleted from the database 32. Therefore, according to this embodiment, a packet concerning which a loss is considered to have occurred can be prevented from remaining in the database 32, so that the amount of memory usage can be further reduced.

### OTHER EMBODIMENTS

The above embodiments can be freely combined, or any constituent element of each of the embodiments can be modified. Alternatively, in each of the embodiments, any constituent element can be omitted.

The embodiments are not limited to those presented in Embodiments 1 and 2, and various modifications can be made as needed. The procedures described using the flowcharts or the like may be suitably modified.

### REFERENCE SIGNS LIST

10: computer, 11: processor, 12: memory, 13: auxiliary storage device, 14: input/output IF, 15: communication device, 18: processing circuit, 19: signal line, 31: whitelist, 32: database, 101: intrusion detection device, 102: network IF, 103: fragment calculation unit, 104: whitelist storage unit, 105: determination unit, 106: alert unit, 107: clock unit, 110: bus.

1. An intrusion detection device that refers to a database storing a whitelist for a packet that conforms to an Internet protocol suite,
the whitelist including entries called normal entries, each of which includes information indicating a transmission source IP address and information indicating a payload,
the intrusion detection device comprising
processing circuitry to:
receive a fragmented packet that conforms to the Internet protocol suite as a received packet, and
perform determination processing, using the received packet, to determine whether each of the normal entries is a partial match entry that is decided depending on the received packet,
wherein a transmission source IP address and a target partial payload that are indicated in the partial match entry respectively match a transmission source IP address and a payload that are indicated in the received packet,
wherein the target partial payload is data located in an area in a payload of the partial match entry, the area starting at a location corresponding to a fragment offset indicated in the received packet, and
wherein a data size of the target partial payload is same as a data size of the payload indicated in the received packet.

2. The intrusion detection device according to claim 1,
wherein each of the normal entries includes information indicating a transmission source port number,
wherein the received packet includes information indicating a transmission source port number, and
wherein a transmission source port number indicated in the partial match entry matches the transmission source port number indicated in the received packet.

3. The intrusion detection device according to claim 1,
wherein the intrusion detection device treats a packet before fragmentation of the received packet as an original packet,
wherein the processing circuitry performs same processing as the determination processing on each different packet that is a fragmented packet of the original packet and is different from the received packet,
wherein the processing circuitry manages, as management data, information that identifies the original packet and each piece of information indicating a normal entry identifier that identifies each partial match entry corresponding to at least one fragmented packet of the original packet in association with each other, and
wherein when data corresponding to the original packet is being managed through the management data, and the processing circuitry has not performed the determination processing on the received packet,
the processing circuitry uses only narrowed-down entries among the normal entries in the determination processing on the received packet, the narrowed-down entries being composed of each normal entry corresponding to each normal entry identifier that corresponds to the original packet and is indicated in the management data, and
the processing circuitry deletes, from the management data, information indicating a normal entry identifier that corresponds to the original packet and corresponds to a normal entry, among normal entries included in the narrowed-down entries, that is determined not to be a partial match entry for the received packet in the determination processing.

4. The intrusion detection device according to claim 2,
wherein the intrusion detection device treats a packet before fragmentation of the received packet as an original packet,
wherein the processing circuitry performs same processing as the determination processing on each different packet that is a fragmented packet of the original packet and is different from the received packet,
wherein the processing circuitry manages, as management data, information that identifies the original packet and each piece of information indicating a normal entry identifier that identifies each partial match entry corresponding to at least one fragmented packet of the original packet in association with each other, and
wherein when data corresponding to the original packet is being managed through the management data, and the processing circuitry has not performed the determination processing on the received packet,
the processing circuitry uses only narrowed-down entries among the normal entries in the determination processing on the received packet, the narrowed-down entries being composed of each normal entry corresponding to each normal entry identifier that corresponds to the original packet and is indicated in the management data, and
the processing circuitry deletes, from the management data, information indicating a normal entry identifier that corresponds to the original packet and corresponds to a normal entry, among normal entries included in the narrowed-down entries, that is determined not to be a partial match entry for the received packet in the determination processing.

5. The intrusion detection device according to claim 3,
wherein the processing circuitry records, as a reception time, a time corresponding to a time of reception of the received packet by the intrusion detection device, and
wherein when a deletion time period has elapsed from the reception time and the processing circuitry is managing data corresponding to the received packet through the management data, the processing circuitry deletes the data corresponding to the received packet in the management data.

6. The intrusion detection device according to claim 4,
wherein the processing circuitry records, as a reception time, a time corresponding to a time of reception of the received packet by the intrusion detection device, and
wherein when a deletion time period has elapsed from the reception time and the processing circuitry is managing data corresponding to the received packet through the management data, the processing circuitry deletes the data corresponding to the received packet in the management data.

7. The intrusion detection device according to claim 1,
wherein the processing circuitry issues an alert when it is determined that the whitelist does not include the partial match entry.

8. The intrusion detection device according to claim 2,
wherein the processing circuitry issues an alert when it is determined that the whitelist does not include the partial match entry.

9. The intrusion detection device according to claim 3,
wherein the processing circuitry issues an alert when it is determined that the whitelist does not include the partial match entry.

10. The intrusion detection device according to claim 4,
wherein the processing circuitry issues an alert when it is determined that the whitelist does not include the partial match entry.

11. The intrusion detection device according to claim 5,
wherein the processing circuitry issues an alert when it is determined that the whitelist does not include the partial match entry.

12. The intrusion detection device according to claim 6,
wherein the processing circuitry issues an alert when it is determined that the whitelist does not include the partial match entry.

13. An intrusion detection method that refers to a database storing a whitelist for a packet that conforms to an Internet protocol suite,
the whitelist including entries called normal entries, each of which includes information indicating a transmission source IP address and information indicating a payload,
the intrusion detection method comprising:
receiving a fragmented packet that conforms to the Internet protocol suite as a received packet; and
performing determination processing, using the received packet, to determine whether each of the normal entries is a partial match entry that is decided depending on the received packet,
wherein a transmission source IP address and a target partial payload that are indicated in the partial match entry respectively match a transmission source IP address and a payload that are indicated in the received packet,
wherein the target partial payload is data located in an area in a payload of the partial match entry, the area starting at a location corresponding to a fragment offset indicated in the received packet, and
wherein a data size of the target partial payload is same as a data size of the payload indicated in the received packet.

14. A non-transitory computer readable medium storing an intrusion detection program that refers to a database storing a whitelist for a packet that conforms to an Internet protocol suite,
the whitelist including entries called normal entries, each of which includes information indicating a transmission source IP address and information indicating a payload,
the intrusion detection program causing an intrusion detection device, which is a computer, to execute:
a fragment calculation process of receiving a fragmented packet that conforms to the Internet protocol suite as a received packet; and
a determination process of determining, using the received packet, whether each of the normal entries is a partial match entry that is decided depending on the received packet,
wherein a transmission source IP address and a target partial payload that are indicated in the partial match entry respectively match a transmission source IP address and a payload that are indicated in the received packet,
wherein the target partial payload is data located in an area in a payload of the partial match entry, the area starting at a location corresponding to a fragment offset indicated in the received packet, and
wherein a data size of the target partial payload is same as a data size of the payload indicated in the received packet.
